(19) United States
(12) Patent Application Publication
(10) Pub. No.: US 2009/0270141 A1
(43) Pub. Date: Oct. 29, 2009

(54) APPARATUS HAVING INPUT MEANS WITH RUGGED SURFACE

(75) Inventor: Jari Sassi, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/111,410

(22) Filed: Apr. 29, 2008

(51) Int. Cl. H04M 1/00

(52) U.S. Cl. 455/575.1

(57) ABSTRACT

The invention relates to a mobile apparatus which comprise a casing provided with input means, at least one accelerometer, and at least one sound detecting device for detecting a sound. The input means comprise an at least partly raised surface, and wherein, when an object is moved over the at least partly raised surface a vibration, detectable by the accelerometer, occurs which, in turn, generates a sound detectable by the sound detecting device. The detected vibration and sound is representative of the length and direction of the movement by the object over the at least partly raised surface.

### TECHNICAL FIELD

The present invention relates to the field of mobile communication devices and, in particularly, to user input means based on markers and accelerometers for mobile communication devices.

### BACKGROUND

The recent years rapid development in microelectronics and telecommunication technology have lead to a widespread use of personal portable terminals such as mobile phones, personal digital assistants (PDAs), media players, portable computers etc. These portable terminals are often used for a multitude of tasks such as speech and text communication, playing music, watching films, browsing the Internet, and reading e-mails. To efficiently handle, and to operate the applications performing these tasks in the portable terminal, it is essential to have robust, efficient, and easy-to-use input means.

The most commonly used input means for navigation and selection operations in terminal based applications are different types of keypads, multidirectional buttons, joysticks, scroll wheels, etc. However, these input means, which mainly consists of movable mechanical parts, suffers from several drawbacks. The mechanical parts are prone to errors due to dust, dirt, moist, and general ware and tear, and additional electronic components, which consume precious space in the terminal, are often needed to translate the mechanical operations into electrical signals. Therefore, replacing these navigation means with more robust and space efficient navigation means is important to manufacturers of portable terminals.

### SUMMARY OF THE INVENTION

With the above and following description in mind, then, an aspect of the present invention is to provide an alternative input means and method, which seeks to mitigate, alleviate, or eliminate one or more of the above-identified deficiencies in the art and disadvantages singly or in any combination.

An aspect of the present invention relates to a mobile apparatus, comprising a casing provided with input means, at least one vibration detecting device, and at least one sound detecting device for detecting a sound; wherein the input means comprises an at least partly rugged surface, and wherein, when an object is moved over the at least partly rugged surface a vibration, detectable by said at least one vibration detecting device, occurs which, in turn, generates a sound detectable by the at least one sound detecting device, said vibration and said sound being representative of the length and direction of the movement by said object over the at least partly rugged surface.

The mobile apparatus may also comprise at least a partly rugged surface comprising a plurality of raised markers.

The mobile apparatus may also comprise a plurality of raised markers of triangular form, and wherein, each of the plurality of raised markers is spaced from an adjacently positioned raised marker such that the plurality of raised markers provides a saw toothed pattern.

The mobile apparatus may also comprise a plurality of raised markers printed on the housing of the mobile apparatus, and wherein, the plurality of raised markers is positioned in at least one row.

The mobile apparatus may also comprise a row of raised markers which extends in a vertical direction of the mobile apparatus such that when an object is moved over the plurality of raised markers a vibration occurs which generates a sound being representative of the length and direction of a movement in the vertical direction.

The mobile apparatus may also comprise a row of raised markers which extends in a horizontal direction of the mobile apparatus such that when an object is moved over the plurality of raised markers a vibration occur which generates a sound being representative of the length and direction of a movement in the horizontal direction.

The mobile apparatus may also comprise a plurality of raised markers are positioned in at least two rows, and a first row extends in a horizontal direction of the mobile apparatus such that when an object is moved over the first row of raised markers a vibration occurs which generates a sound being representative of the length and direction of a movement in the horizontal direction and a second row extends in a vertical direction of the mobile apparatus such that when an object is moved over the second row of raised markers a vibration occurs which generates a sound being representative of the length and direction of a movement in the vertical direction;

The mobile apparatus may also incorporate an accelerometer.

The mobile apparatus may also incorporate a sound detecting device is a microphone.

The mobile apparatus may use a vibration detecting device or the sound detecting device to detect said length and direction of said movement.

The mobile apparatus may be an apparatus from the group comprising a portable radio communication equipment, a mobile radio terminal, a mobile telephone, a cellular telephone, a pager, a communicator, an electronic organizer, a smart phone and a computer.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a mobile communication device, in this case a mobile phone, according to an embodiment of the present invention; and

FIG. 2 shows a user using his or hers finger to scratch on one of the markers placed on the side of the mobile communication device, according to an embodiment of the present invention; and

FIG. 3 shows a side view of the mobile communication device in FIG. 2 with added markers on the side and on the top, according to an embodiment of the present invention; and

FIG. 4 shows a mobile communication device with added markers, according to an embodiment of the present invention.

### DETAILED DESCRIPTION

Embodiments of the present invention relate, in general, to the field of user input means in mobile communication apparatuses. A preferred embodiment relates to a portable communication device, such as a mobile phone, including one or more marker input devices. However, it should be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

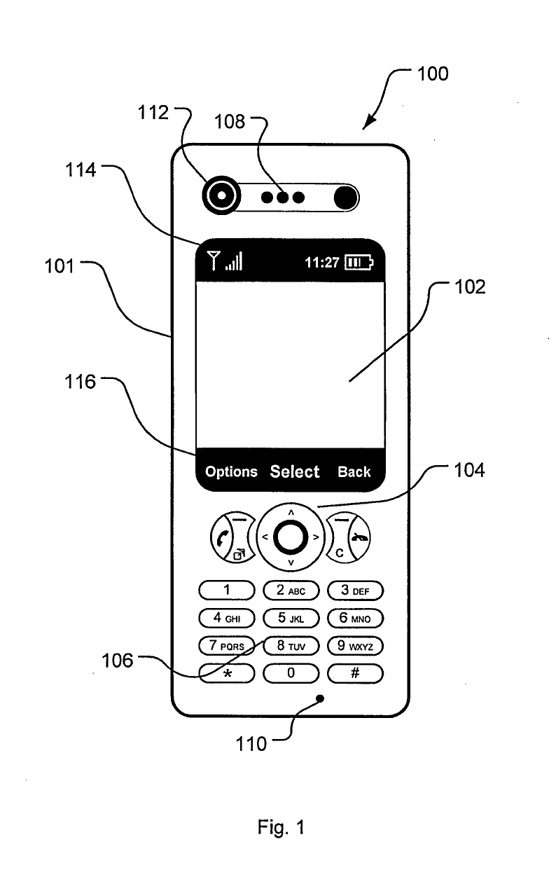

FIG. 1 show a mobile communication device 100 comprising a casing 101, a display area 102 and means 104 for navigating among items (not shown) displayed in the display area. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile communication apparatus 100 can also comprise other elements normally present in such a device, such as a keypad 106, a speaker 108, one or more microphones 110, a camera 112, a processor (not shown), a memory (not shown), one or more accelerometers (not shown), a vibration device (not shown), an AM/FM radio transmitter and receiver (not shown), a digital audio broadcast transmitter and receiver (not shown), etc.

As discussed in the background section, navigation means containing movable mechanical parts, such as joysticks and scroll wheels, are often prone to errors and consumes valuable internal space in the portable terminal. Finding more robust and space conservative navigation means which may replace the mechanical based navigation means are highly sought for. The present invention eliminates the use of mechanical based navigation means such as joysticks and scroll wheels by utilizing one or more accelerometers together with one or more markers which are placed on the casing of the mobile communication device.

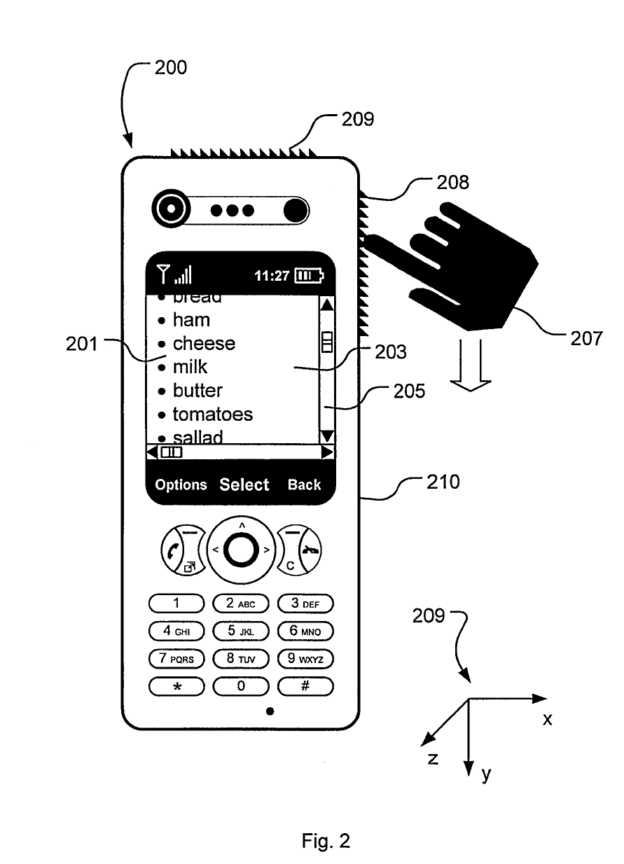

In one embodiment of the present invention, one or more accelerometers are implemented inside the mobile communication device. The accelerometers register all movements and vibrations of the communication device that occurs in all three space dimensions (x, y, and z). As shown in FIG. 2, markers 208, 209 are attached and/or incorporated into the device casing 210. The markers 208, 209 have preferably a rugged surface which when a user slides, rub, or scratch his or hers finger 207 or any pen-like object over the surface, it will generate vibrations which are registered by the accelerometer in the device. The surface of the markers can be of any type of raised or depressed pattern, or both, which will generate a vibration when scratched. The pattern itself may either be uniform (repetitive) or non-uniform (non-repetitive) to its design.

In one embodiment the markers consists of a raised slanted jagged pattern (saw tooth pattern), as shown in 208 and 209, in FIG. 2. The saw tooth pattern will generate two distinct vibration patterns, detectable by the accelerometers, when scratched in opposite directions (against or along the saw tooth pattern). In this way it is possible to determine in which direction the finger 207, or a pen-like object, has scratched the marker surface. This directional determination may then, for instance, be used to perform a scrolling operation. For example, a user of a mobile communication device 200 is out shopping for groceries. The user's grocery list 201 is displayed on the mobile communication devices 200 display screen 203. As indicated by the scroll list 205 in the figure, the grocery list contains more items than it is possible to display in the display screen at once. To scroll the list the user scratches/rubs his or hers finger 207 on the marker 208 with the raised saw tooth pattern. The accelerometer(s) in the device 200 registers a vibration pattern, predominant in the space direction x 209, coming from the user's scratching. The registered vibration is interpreted, signal processed, and turned into a scrolling operation (in space direction y), and hence the grocery list displayed on the display screen is scroll. If the user scratches/rubs his or hers finger in the opposite direction (against the raised saw tooth pattern) another vibration pattern different from the first one (in space direction x) is detected. In the same manner the new vibration pattern will be registered by the accelerometer(s), signal processed, and interpreted as a scroll operation in the opposite direction (space direction −y). Also, if the user scratches the marker 209 placed on top of the mobile communication device 200, a vibration pattern predominant in space direction y will be detected and interpreted as a scroll operation in space direction x or −x depending on if the marker is scratched in one or the other direction.

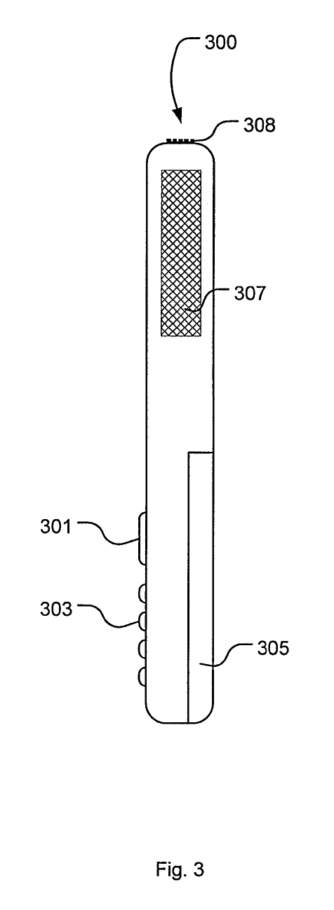

FIG. 3 shows a side view of the mobile communication device in FIG. 2. As indicated in the figure, raised markers are placed both on the side 307, just above the battery hatch 305, of the communication device 300, and on the top of the device 208. The side view perspective also shows the key pad 303 and navigation buttons 301 of the communication device. The raised saw tooth pattern used in 307 and 308 may be implemented using only one row of saw tooth pattern (a single line of teeth) or, as shown in FIG. 3, a multitude of rows of saw tooth pattern (several lines of teeth).

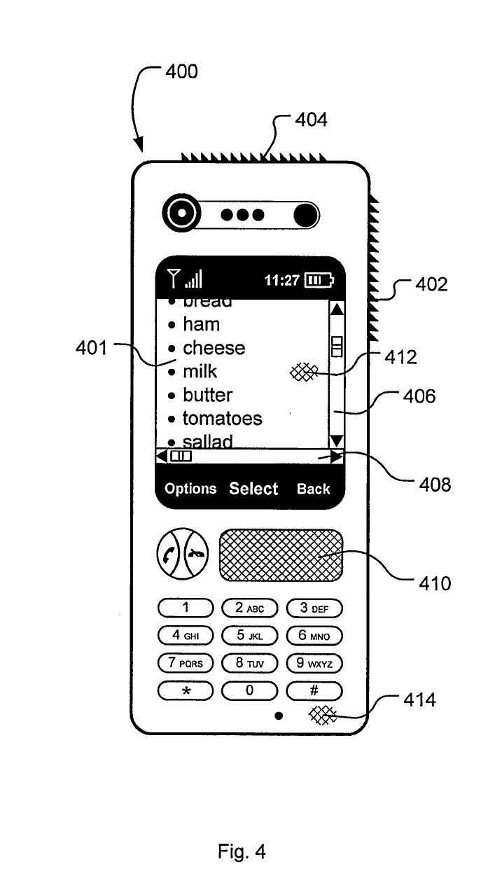

As shown in FIG. 4, markers may come in any shape or form and may be placed anywhere on the casing of a mobile communication device 400. In one embodiment even the casing itself 414 may be manufactured with marker pattern on it. Adhesive markers may also be supplied with the mobile communication device which may be placed by the user on any suitable surface, for example on the front 410 under the display screen 401. In this way the user may tailor his or hers mobile communication device to suite his or hers own needs.

In another embodiment, a display screen 410 may be fitted with a transparent marker 412, thus acting as, and replacing, the expensive touch screen.

In yet another embodiment, the operation of one or all accelerometers may be replaced by one or more microphones in the mobile communication device. The sound coming from the scratching of the markers may be picked up by the microphone in a similar manner as the vibrations were detected by an accelerometer. The scratching sound will then be signal processed and interpreted as for example a scrolling operation. The sound will be different (pitch, frequency, etc.) depending on in which direction the raised marker pattern is scratched, thus making it possible to determine in which direction the marker was scratched.

In yet another embodiment both an accelerometer(s) and a microphone(s) may be used simultaneously to detect the scratching.

The pattern and the material of the marker may be done in several different ways. The pattern on the marker may be configured in any three-dimensional way (raised, depressed, slanted, jagged, etc.) to produce a sound and/or a vibration that will be different (or the same) depending on in which direction the marker pattern is scratched.

The marker material may be made of a transparent or a non-transparent (coloured or non-coloured) material which may blend in with the design of the mobile communications device. The material itself may be of any hard, semi-hard, or soft material, such as for example rubber, metal, glass, plastic, etc., which will produce a vibration and/or sound when scratched.

A user may also scratch two or more raised markers at the same time. The accelerometer(s) and/or the microphone(s) will detect the two or more scratches and interpret, by signal processing, it as either two (or more) user scratches or as one combined user scratch. In this way the user, or the manufacturer, may define three separate operations using only two raised markers. For instance, scratching the side marker 402 in FIG. 4 will scroll up/down the content in the display, scratching the front maker 410 in FIG. 4 will scroll right/left the content in the display, scratching both markers 410, 402 simultaneously will for instance close or minimise the application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A mobile apparatus, comprising:
a casing provided with input means,
at least one vibration detecting device, and
at least one sound detecting device for detecting a sound; wherein
the input means comprises an at least partly rugged surface, and wherein, when an object is moved over the at least partly rugged surface a vibration, detectable by said at least one vibration detecting device, occurs which, in turn, generates a sound detectable by the at least one sound detecting device, said vibration and said sound being representative of the length and direction of the movement by said object over the at least partly rugged surface.

2. The mobile apparatus as recited in claim 1, wherein the at least partly rugged surface comprises a plurality of raised markers.

3. The mobile apparatus as recited in claim 2, wherein each of the plurality of raised markers comprises a triangular form, and wherein, each of the plurality of raised markers is spaced from an adjacently positioned raised marker such that the plurality of raised markers provides a saw toothed pattern.

4. The mobile apparatus as recited in claim 2, wherein the plurality of raised markers is printed on the housing of the mobile apparatus, and wherein, the plurality of raised markers is positioned in at least one row.

5. The mobile apparatus as recited in claim 4, wherein the row of raised markers extends in a vertical direction of the mobile apparatus such that when an object is moved over the plurality of raised markers a vibration occurs which generates a sound being representative of the length and direction of a movement in the vertical direction.

6. The mobile apparatus as recited in claim 4, wherein the row of raised markers extends in a horizontal direction of the mobile apparatus such that when an object is moved over the plurality of raised markers a vibration occur which generates a sound being representative of the length and direction of a movement in the horizontal direction.

7. The mobile apparatus as recited in claim 4, wherein:
the plurality of raised markers are positioned in at least two rows, and
a first row extends in a horizontal direction of the mobile apparatus such that when an object is moved over the first row of raised markers a vibration occurs which generates a sound being representative of the length and direction of a movement in the horizontal direction; and
a second row extends in a vertical direction of the mobile apparatus such that when an object is moved over the second row of raised markers a vibration occurs which generates a sound being representative of the length and direction of a movement in the vertical direction;

8. The mobile apparatus as recited in claim 1, wherein the vibration detecting device is an accelerometer.

9. The mobile apparatus as recited in claim 1, wherein the sound detecting device is a microphone.

10. The mobile apparatus as recited in claim 1, wherein only the said vibration detecting device or the sound detecting device is used to detect said length and direction of said movement.

11. The mobile apparatus of claim 1, wherein the mobile apparatus is an apparatus from the group comprising: a portable radio communication equipment, a mobile radio terminal, a mobile telephone, a cellular telephone, a pager, a communicator, an electronic organizer, a smart phone and a computer.
